(19) United States
(12) Patent Application Publication
(10) Pub. No.: US 2021/0053204 A1
(43) Pub. Date: Feb. 25, 2021

(54) WHEEL DETAILING STAND

(71) Applicant: The Source Garage LLC, Menomonee Falls, WI (US)

(72) Inventor: Samuel Graves, Menomonee Falls, WI (US)

(21) Appl. No.: 16/947,768

(22) Filed: Aug. 17, 2020

Related U.S. Application Data
(60) Provisional application No. 62/888,586, filed on Aug. 19, 2019.

(51) Int. Cl. B25H 1/00; B60S 3/04

(52) U.S. Cl. CPC B25H 1/0042; B60S 3/042

(57) ABSTRACT

A wheel detailing stand that provides for 3-point contact with a wheel mounted thereon is disclosed. The wheel detailing stand includes a base frame having a bottom frame member and a back frame member extending upwardly from the bottom frame member, a pair of bottom rollers attached to the bottom frame member where the pair of rollers are arranged in parallel and spaced apart from one another, and a back roller attached to the back frame member and oriented generally orthogonally to the pair of bottom rollers. The pair of bottom rollers and the back roller provide 3-point contact with a wheel positioned on the wheel detailing stand.

### CROSS-REFERENCE TO RELATED APPLICATION

The present invention is a non-provisional of and claims priority to U.S. Provisional Patent Application Ser. No. 62/888,586, filed Aug. 19, 2019, the disclosure of which is incorporated herein by reference in its entirety.

### BACKGROUND OF THE INVENTION

Embodiments of the invention relate to a wheel detailing stand. More particularly, embodiments of the invention relate to a wheel detailing stand that provides for 3-point contact with a wheel mounted thereon, so as enable a smooth, one-handed manipulation of a wheel mounted on the stand while securing the wheel thereon in a stable fashion. Embodiments of the invention also relate to a rotatable wheel detailing stand that enables 360° access to a wheel mounted on the stand.

Auto detailing is the act of performing a thorough cleaning, restoration, and finishing of a motor vehicle, to produce a show-quality cleanliness and polish. Detailing can be performed on a vehicle's exterior and/or interior—with exterior detailing involving cleaning, and either restoring or exceeding the original condition of the surface of the car's finish (usually a paint with a glossy finish), chrome trim, windows, wheels, and tires, as well as other visible components on a vehicle's exterior. A wide array of detailing products and techniques is used, based on the vehicle's surface type and condition, or the detailer's preference. Products include, but are not limited to: detergents and acid free degreasers (to break down dirt and soil), detail clay (to remove embedded contaminates), waxes, shines, and polishes (to resurface and then improve reflectivity, or to give the tires a shine), as well as a variety of applicators, brushes, and drying towels.

With particular regard to wheel or tire detailing, the wheel may be cleaned to remove dirt from the wheel (such as brake dust, grime, mud, tar and more) and/or to polish or detail the wheel in another manner to enhance the appearance thereof. In detailing the wheel, and upon removal of the wheel from a vehicle/bike to which it is attached, the wheel is typically positioned on a detailing stand that allows for the wheel to be easily manipulated for cleaning and other detailing work. Typical detailing stands often include a base frame having a pair of spaced-apart rollers thereon, with the wheel resting on the pair of rollers so as to enable rotation of the wheel.

While a detailing stand as described above provides for easy manipulation and rotation of the wheel via the pair of spaced-apart rollers, there are drawbacks to such a stand design. For example, as the wheel is only supported on the stand via the rollers underneath the wheel, stability of the wheel is not ideal—with tipping of the wheel backward/forward potentially occurring when pressure is applied to the wheel during cleaning or other detailing tasks. Additionally, existing stands are often stationary and either require manipulation of the wheel or repositioning of the stand in order to provide access to all sides/surfaces of the wheel.

Therefore, it is desirable to provide a detailing stand configured such that stability of the wheel may be maintained while cleaning or other detailing of the wheel is being performed. It is also desirable to provide a detailing stand that can be easily manipulated to provide 360° access to a wheel mounted thereon. Such a detailing stand would also provide additional flexibility in controlling movement of the wheel, such as selectively preventing rotation of the rollers and angling of the wheel in a desired orientation, for example.

### BRIEF DESCRIPTION OF THE INVENTION

In accordance with one aspect of the invention, a wheel detailing stand includes a base frame having a bottom frame member and a back frame member extending upwardly from the bottom frame member, a pair of bottom rollers attached to the bottom frame member where the pair of rollers are arranged in parallel and spaced apart from one another, and a back roller attached to the back frame member and oriented generally orthogonally to the pair of bottom rollers. The pair of bottom rollers and the back roller provide 3-point contact with a wheel positioned on the wheel detailing stand.

In accordance with another aspect of the invention, a wheel detailing stand for detailing or cleaning a wheel includes a base frame and a plurality of idle rollers positioned on the base frame and arranged thereon to receive the wheel and provide 3-points of contact with the wheel.

These and other advantages and features will be more readily understood from the following detailed description of preferred embodiments of the invention that is provided in connection with the accompanying drawings.

### BRIEF DESCRIPTION OF THE DRAWINGS

The drawings illustrate embodiments presently contemplated for carrying out the invention.

In the drawings:

FIG. 1. is a perspective view of a wheel detailing stand, according to an embodiment of the invention.

FIG. 2 is a perspective view of the wheel detailing stand of FIG. 1 folded into a storage position, according to an embodiment of the invention.

FIG. 3 is a close-up view of a roller brake included on the wheel detailing stand of FIG. 1, according to an embodiment of the invention.

FIG. 4 is a perspective view of a wheel detailing stand, according to another embodiment of the invention.

FIGS. 5-8 are perspective views of a wheel detailing stand, according to another embodiment of the invention.

FIG. 9 is a view of a bottom plate and roller balls included in the wheel detailing stand of FIGS. 5-8, according to an embodiment of the invention.

FIG. 10 is a perspective view of a wheel detailing stand, according to another embodiment of the invention.

FIG. 11 is a close-up view of a portion of the wheel detailing stand of FIG. 10, illustrating an alternative means for securing the back frame member to the bottom frame member, according to another embodiment of the invention.

### DETAILED DESCRIPTION

Embodiments of the invention are directed to a wheel detailing stand that is configured such that stability of the wheel may be maintained while cleaning or other detailing of the wheel is being performed and/or such that the wheel can be easily manipulated to provide 360° access thereto while mounted on the wheel detailing stand. In one embodiment, the wheel detailing stand includes a base frame having an arrangement of idle rollers thereon that provide for 3-point contact with a wheel mounted thereon—with a pair of rollers arranged in parallel so as to be positioned underneath a wheel mounted on the stand and a single roller arranged substantially orthogonally to the pair of rollers so as to be positioned behind a wheel mounted on the stand. In another embodiment, the wheel detailing stand includes a base frame having a bottom frame member having a top plate that is rotatable relative to a bottom plate, with the top plate having an arrangement of idle rollers thereon on which a wheel can be mounted. The embodiments of the wheel detailing stand provide for easy manipulation of a wheel mounted on the stand, while ensuring stability of the wheel during a detailing operation.

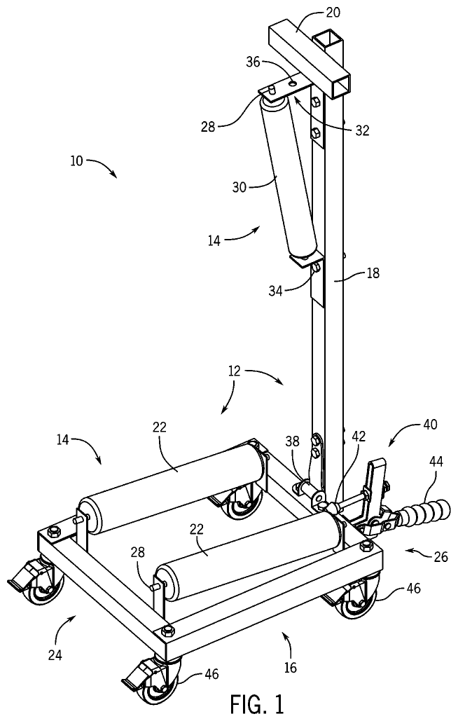

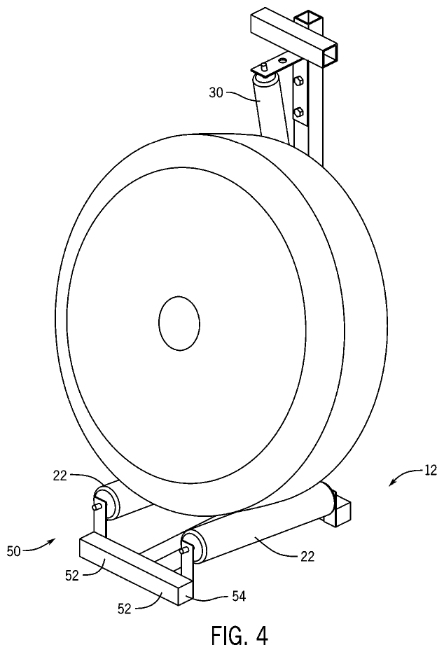

Referring to FIG. 1, a wheel detailing stand 10 is shown according to an embodiment of the invention. The wheel detailing stand 10 generally includes a base frame 12 and an arrangement of idle rollers 14 mounted thereon that provide for 3-point contact with a wheel mounted thereon (such as shown in FIG. 4). The base frame 12 comprises a bottom frame member 16 having a generally horizontal orientation so as to be parallel to a ground surface, as well as a back frame member 18 attached to the bottom frame member 16 and extending upwardly therefrom in a generally vertical orientation. In the illustrated embodiment, the top end of the back frame member 18 includes a T-handle 20 thereon that enables easy handling and transport of the detailing stand 10 around the shop.

As shown in FIG. 1, a pair of bottom rollers 22 is secured to bottom frame member 16 such that the bottom rollers 22 are arranged in parallel and in a spaced-apart manner. The bottom rollers 22 are thus arranged so as to be positioned underneath a wheel mounted on the detailing stand 10. Each of the bottom rollers 22 extends generally from a front end 24 to a back end 26 of the bottom frame member 16, with the bottom rollers 22 having a length that accommodates positioning of wheels thereon of various sizes and types. In an exemplary embodiment, roller bearings (not shown) are included inside the bottom rollers 22 to allow for a smooth, one-handed manipulation of a wheel mounted on the detailing stand 10. Additionally, spring retention shafts 28 may be provided on the bottom rollers 22 to allow for easy removal thereof from bottom frame member 16, so as to enable cleaning, painting, and/or replacement of the rollers.

As further shown in FIG. 1, a back roller 30 is secured to back frame member 18 such that the back roller 30 is positioned behind a wheel mounted on the detailing stand 10. The back roller 30 is secured to back frame member 18 via top and bottom mounting brackets 32, 34. The top mounting bracket 32 may extend out further from back frame member 18 than the bottom mounting bracket 34, such that the back roller 30 will be mounted at an angle relative to back frame member 18. The angling of the back roller 30 may beneficially provide a solid point of contact with a wheel mounted on the detailing stand 10. According to one embodiment, the top mounting bracket 32 may include a plurality of holes 36 formed therein in which back roller 30 may be mounted. The mounting of back roller 30 within a selective hole of the plurality of holes 36 allows for a desired angling/positioning of the back roller 30 (including the back roller 30 sitting parallel to the back frame member 18), which may be determined at least in part by the size of the wheel on the detailing stand 10, for example.

According to an exemplary embodiment, bottom rollers 22 are angled/oriented relative to the bottom frame member 16 (and to the floor) such that the front of the rollers 22 is raised relative to the back of the rollers 22. The angling of bottom rollers 22 in this orientation aids in tilting a wheel positioned on the wheel detailing stand 10 such that the wheel leans back against the back roller 30—thereby ensuring 3-point contact between the bottom and back rollers 22, 30 and the wheel. It is recognized, however, that the bottom rollers 22 can be set parallel to the floor, according to an alternative embodiment.

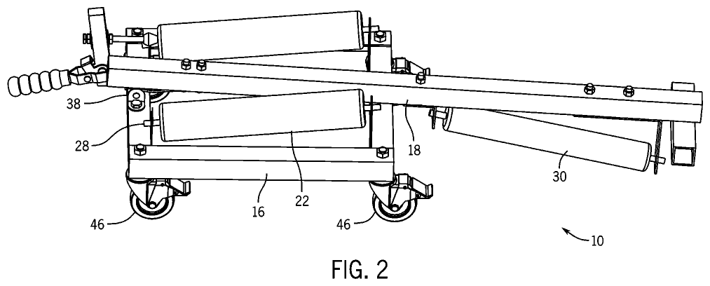

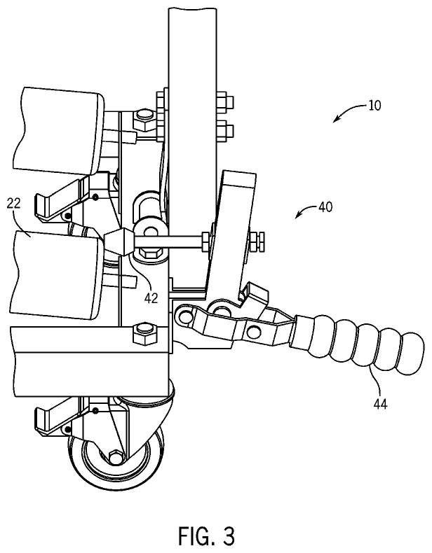

Referring now to FIG. 2, it is illustrated that the detailing stand 10 may be configured so as to provide for reconfiguring of the stand into a storage position (FIG. 3) when not in use. To reconfigure the detailing stand 10 into the storage position, a hinge 38 is included at the base of the back frame member 18—with the back frame member 18 secured to the bottom frame member 16 via the hinge 38. The hinge 38 enables rotation of the back frame member 18 relative to the bottom frame member 16, such as the back frame member 18 being folded down over the bottom frame member 16, such that the detailing stand 10 can fold in half to greatly reduce the height of the detailing stand 10.

In an alternative embodiment, the base frame 12 may be constructed to include a hitch pin thereon in place of hinge 38. The hitch pin may be provided to allow for the selective attachment and removal of the back frame member 18 to/from the bottom frame member 16, so as to provide for easy transportation and storage of the detailing stand 50

Referring now to FIG. 3, according to one embodiment, detailing stand 10 further includes one or more roller brakes 40 mounted to the bottom frame member 16 (such as via one or more fasteners) to enable selective locking of the respective bottom roller(s) in place. In the illustrated embodiment, a roller brake 40 is provided on one of the bottom rollers 22, with the roller brake 40 provided in the form of a toggle clamp—hereinafter toggle clamp 40. The toggle clamp 40 may include a stop member 42 that may selectively translated towards or away from a bottom roller 22 via actuation of a handle 44—with the stop member 42 being brought into contact with a bottom roller 22 and locked into place to prevent rotation of the bottom roller 22. By selectively bringing the roller brake 40 into contact with a bottom roller 22, bottom roller 22 may be locked into a stationary position—such that rotation of a wheel mounted on the detailing stand 10 may be prevented as desired during certain detailing tasks.

As shown best in FIGS. 1 and 2, according to one embodiment, the base frame 12 may include a plurality of wheels 46 thereon that are secured to the bottom frame member 16. A wheel 46 may be provided at each of four corners of the bottom frame member 16, so as to provide for movement of the detailing stand 10 to a desired location within the shop.

Referring now to FIG. 4, a wheel detailing stand 50 is shown according to another embodiment of the invention. The wheel detailing stand 50 is similar to the wheel detailing stand of FIGS. 1-3, specifically with regard to the arrangement of bottom rollers 22 and back roller 30 of the detailing stand 50. However, in the embodiment of FIG. 4, the base frame 12 is constructed to include a plurality of base feet 52 thereon in place of the wheels 46 included on the detailing stand of FIGS. 1-3. The base feet 52 may be provided at the four corners of the bottom frame member 16 and on a bottom surface thereof, to provide a stable base for the detailing stand 50. The base feet 52 may be configured as rubber feet that prevent scratching of paint on the frame and/or a working surface. The base feet 52 may also include capped ends 54 thereon to prevent ingress of moisture and dirt into the base frame 12, so as to prevent internal corrosion of the base frame 12.

It is recognized that the specific construction of the wheel detailing stand 10 can vary without departing from the scope of the invention. For example, the dimensions of the base frame 12—including the height of the back frame member 18—may be varied/increased to create more separation between the T-handle 20 and top mounting bracket 32 on back frame member 18.

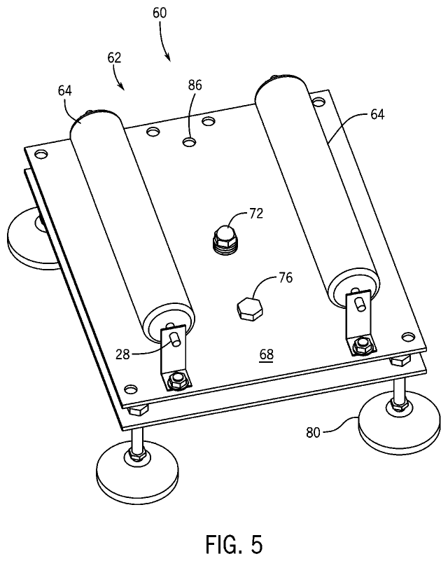

Referring now to FIGS. 5-8, a wheel detailing stand 60 is shown according to another embodiment of the invention. The wheel detailing stand 60 generally includes a bottom frame member 62 and a pair of bottom idle rollers 64 mounted thereon that provide for positioning of a wheel thereon. The bottom frame member 62 is comprised of a bottom plate 66 and a top plate 68 mounted in parallel to one another in a spaced apart relationship, with each having a generally horizontal orientation so as to be parallel to a ground surface. As will be explained in greater detail below, the bottom frame member 62 is structured as a rotatable frame in that the top plate 68 is selectively rotatable to the bottom plate 66. Accordingly, the wheel detailing stand 60 may be easily manipulated to provide for rotation of a wheel mounted on bottom idle rollers 64, and enabling 360° access to the wheel for performing detailing thereon.

As shown in FIGS. 5-8, the pair of bottom rollers 64 is secured to top plate 68 such that the rollers 64 are arranged in parallel and in a spaced-apart manner. The rollers 64 are thus arranged so as to be positioned underneath a wheel mounted on the detailing stand 60. Each of the rollers 64 extends generally from a front end to a back end of the top plate 68, with the rollers 64 having a length that accommodates positioning of wheels thereon of various sizes and types. In an exemplary embodiment, bearings (not shown) are included inside the rollers 64 to allow for a smooth, one-handed manipulation of a wheel mounted on the detailing stand 60. Additionally, spring retention shafts 28 may be provided on the bottom rollers 64 to allow for easy removal thereof from top plate 68, so as to enable cleaning, painting, and/or replacement of the rollers 64.

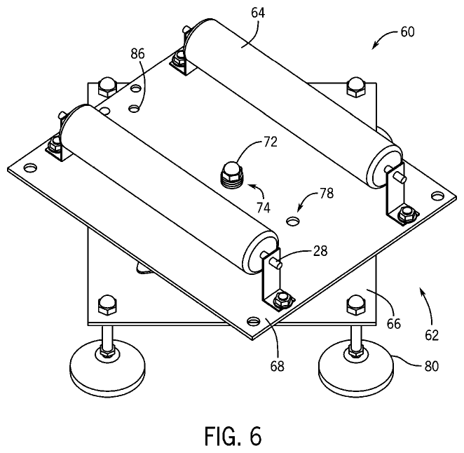

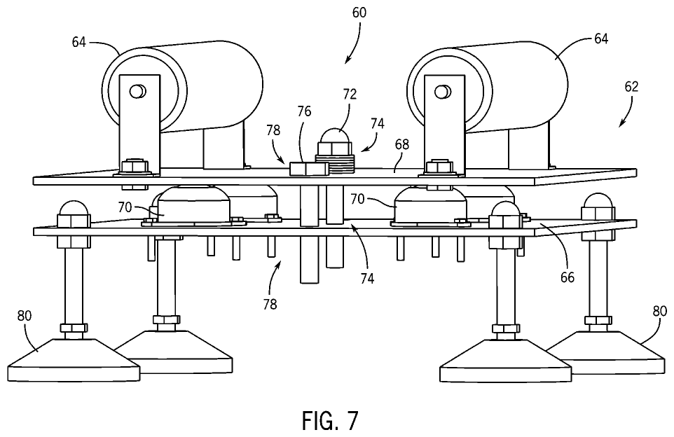

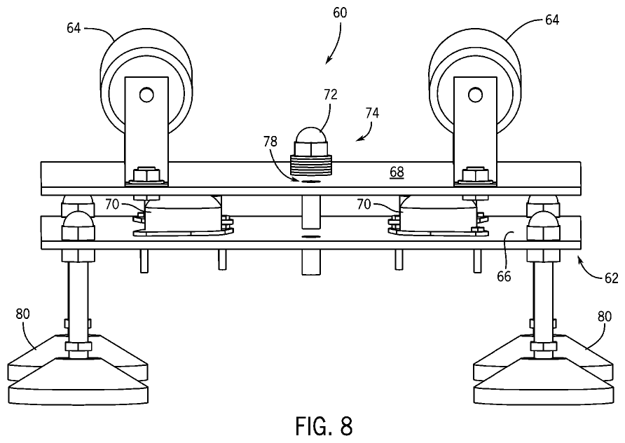

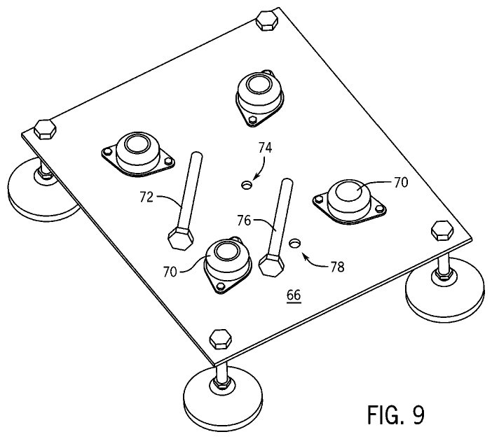

In order to provide for rotation of the top plate 68 relative to the bottom plate 66, a plurality of roller ball transfer bearings (i.e., “roller balls”) 70 are positioned between bottom plate 66 and top plate 68, as shown in FIGS. 5-8 and also in FIG. 9. In the illustrated embodiment, four roller balls 70 are provided in bottom frame member 62, but it is recognized that a greater or lesser number of roller balls 70 could be used. The roller balls 70 are secured in place to bottom plate 66 via a plurality of fasteners (FIG. 9), and the top plate 68 rests on top of the roller balls 70. A pivot pin 72 is provided in bottom frame member 62 that rotatably couples the top plate 68 to the bottom plate 66, with the pivot pin 72 extending through pivot pin holes 74 in the top and bottom plates 68, 66 that are aligned with one another. In order to selectively enable and prohibit rotation between the top plate 68 and the bottom plate 66, a locking pin 76 is provided in bottom frame member 62 that may be selectively inserted and removed from locking pin holes 78 in the top and bottom plates 68, 66. With the locking pin 76 inserted in locking pin holes 78, such as shown in FIGS. 5 and 7, the top plate 68 is locked in place relative to the bottom plate 66 and rotation therebetween is inhibited. With the locking pin 76 removed from the locking pin holes 78, such as shown in FIGS. 6 and 8, the top plate 68 is free to rotate relative to the bottom plate 66, so as to provide for rotation of the wheel on detailing stand 60 to a desired position. While a single locking pin hole 78 is shown in each of top and bottom plates 68, 66 in the illustrated embodiment, it is recognized that bottom plate 66 may include multiple locking pin holes 78 formed therein that are angularly spaced apart about a range of rotation. For example, a plurality of locking pin holes 78 may be positioned 90° apart from each other in the bottom plate 66 so as to allow the top plate 68 to be rotated to and locked in a plurality of distinct positions relative thereto—thereby providing greater control as to the rotational positioning of the wheel when mounted on detailing stand 60.

As shown in FIG. 5-8, according to one embodiment, the detailing stand 60 may include base feet 80 at the four corners of the bottom plate 66 to provide a stable base for the detailing stand 60. The base feet 80 may be configured as rubber feet that prevent scratching of paint on the frame and/or a working surface. According to another embodiment, wheels could instead be substituted for the base feet 80 in order to provide for greater mobility of the detailing stand 60.

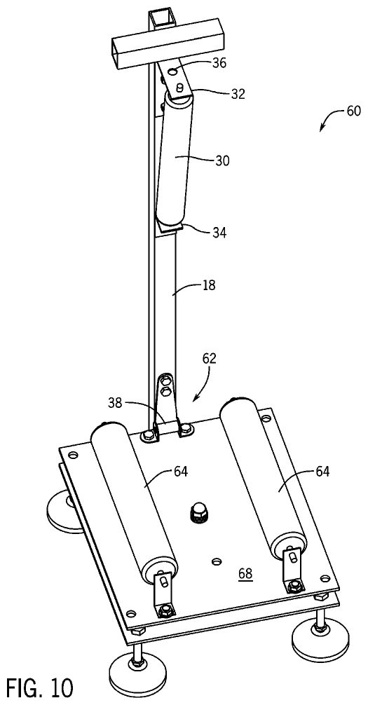

Referring now to FIG. 10, according to one embodiment, wheel detailing stand 60 may further include a back frame member 18 coupled to bottom frame member 62, with the back frame member 18 including a back roller 30 secured thereto. According to the illustrated embodiment, back frame member 18 and back roller 30 may be constructed identical to the back frame member 18 and back roller 30 shown/described in FIG. 1. That is, back roller 30 is secured to back frame member 18 such that the back roller 30 is positioned behind a wheel mounted on the detailing stand 60. The back roller 30 is secured to back frame member 18 via top and bottom mounting brackets 32, 34. The top mounting bracket 32 may extend out further from back frame member 18 than the bottom mounting bracket 34, such that the back roller 30 will be mounted at an angle relative to back frame member 18. The angling of the back roller 30 may beneficially provide a solid point of contact with a wheel mounted on the detailing stand 60. According to one embodiment, the top mounting bracket 32 may include a plurality of holes 36 formed therein in which back roller 30 may be mounted. The mounting of back roller 30 within a selective hole of the plurality of holes 36 allows for a desired angling/positioning of the back roller 30 (including the back roller 30 sitting parallel to the back frame member 18), which may be determined at least in part by the size of the wheel on the detailing stand 60, for example.

In the embodiment of FIG. 10, bottom rollers 64 may be angled/oriented relative to the bottom frame member 62 (and to the floor) such that the front of the rollers 64 is raised relative to the back of the rollers 64. The angling of bottom rollers 64 in this orientation aids in tilting a wheel positioned on the wheel detailing stand 60 such that the wheel leans back against the back roller 30—thereby ensuring 3-point contact between the bottom and back rollers 64, 30 and the wheel.

In the embodiment of FIG. 10, back frame member 18 is secured to the bottom frame member 62 via a hinge 38, with the hinge 38 coupled to back frame member 18 and top plate 68 using fasteners, for example. The hinge 38 enables rotation of the back frame member 18 relative to the bottom frame member 62, such as the back frame member 18 being folded down over the bottom frame member 62, thereby enabling the detailing stand 10 to fold in half to greatly reduce the height of the detailing stand 60 (i.e., a storage position).

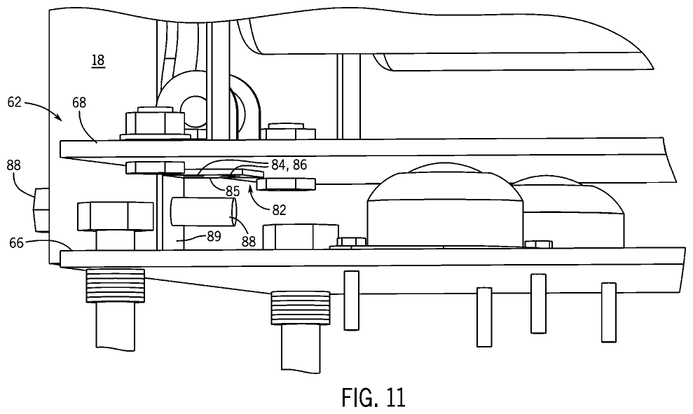

In an alternative embodiment, and as illustrated in FIG. 11, a bracket 82 is provided to secure back frame member 18 to the bottom frame member 62. The bracket 82 is constructed as an L-bracket and may be secured to a bottom facing surface of the top plate 68 via fasteners being inserted through one or more openings 84 in a first leg of the bracket 82 and one or more openings 86 (also shown in FIGS. 5 and 6) in the top plate 68. Alternatively, the bracket 82 may be secured to an upward facing surface of the bottom plate 66 via fasteners being inserted through openings 84 in a first leg 85 of the bracket 82 and openings in the bottom plate 66. A hitch pin or bolt 88 may then secure the back frame member 18 by being inserted through an opening in the back frame member 18 and through an opening in a second leg 89 of the bracket 82.

Beneficially, embodiments of the invention thus provide a wheel detailing stand that exhibits improved stability and functionality as compared to previous detailing stands. According to one embodiment, the arrangement of idle rollers on the detailing stand provides for 3-point contact with a wheel mounted thereon, such that stability of the wheel may be maintained while cleaning or other detailing of the wheel is being performed. According to another embodiment, the bottom frame member of the wheel detailing stand may be constructed as a rotatable base that may be manipulated to provide 360° access to the wheel mounted thereon. Additional features provide for easy and efficient transport and storage of the detailing stand.

Therefore, according to one embodiment of the invention, a wheel detailing stand includes a base frame having a bottom frame member and a back frame member extending upwardly from the bottom frame member, a pair of bottom rollers attached to the bottom frame member where the pair of rollers are arranged in parallel and spaced apart from one another, and a back roller attached to the back frame member and oriented generally orthogonally to the pair of bottom rollers. The pair of bottom rollers and the back roller provide 3-point contact with a wheel positioned on the wheel detailing stand.

According to another embodiment of the invention, a wheel detailing stand for detailing or cleaning a wheel includes a base frame and a plurality of idle rollers positioned on the base frame and arranged thereon to receive the wheel and provide 3-points of contact with the wheel.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A wheel detailing stand comprising:
a base frame including:
a bottom frame member; and
a back frame member extending upwardly from the bottom frame member;
a pair of bottom rollers attached to the bottom frame member, the pair of rollers arranged in parallel and spaced apart from one another; and
a back roller attached to the back frame member and oriented generally orthogonally to the pair of bottom rollers;
wherein the pair of bottom rollers and the back roller provide 3-point contact with a wheel positioned on the wheel detailing stand.

2. The wheel detailing stand of claim 1 further comprising a top mounting bracket and a bottom mounting bracket coupled to the back frame member and to the back roller, so as to secure the back roller to the back frame member.

3. The wheel detailing stand of claim 2 wherein the top mounting bracket extends out from the back frame member a distance greater than which the bottom mounting bracket extends out from the back frame member, such that the back roller is mounted at an angle relative to the back frame member to provide a solid point of contact with the wheel.

4. The wheel detailing stand of claim 2 wherein the top mounting bracket comprises a plurality of openings therein, and wherein the back roller is coupled to the top mounting bracket via one of the openings, such that the angle of the back roller relative to the back frame member is adjustable.

5. The wheel detailing stand of claim 1 wherein the bottom rollers are angled relative to the bottom frame member such that a front end of the rollers is raised relative to a back end of the rollers, so as to tilt the wheel positioned on the wheel detailing stand back against the top roller.

6. The wheel detailing stand of claim 1 further comprising a hinge that couples the back frame member to the bottom frame member, the hinge enabling rotation of the back frame member down over the bottom frame member.

7. The wheel detailing stand of claim 1 further comprising a hitch pin that selectively couples the back frame member to the bottom frame member, the hitch pin providing for attachment and removal of the back frame member 18 to and from the bottom frame member.

8. The wheel detailing stand of claim 1 further comprising a roller brake mounted to the bottom frame member and operable to selectively lock a respective bottom roller of the pair of bottom rollers in place.

9. The wheel detailing stand of claim 1 wherein the roller brake comprises a toggle clamp that includes:
a handle; and
a stop member operatively connected to the handle and selectively translatable towards and away from the respective bottom roller via actuation of the handle;
wherein the stop member is movable so as to be brought into contact with the bottom roller and locked into place to prevent rotation of the bottom roller.

10. The wheel detailing stand of claim 1 further comprising one of:
a plurality of wheels secured to the bottom frame member to provide for movement of the wheel detailing stand; or
base feet secured to the bottom frame member that provide a base for the wheel detailing stand.

11. The wheel detailing stand of claim 1 wherein each of the pair of bottom rollers and the back roller includes a spring retention shaft that provides for removal thereof from the bottom frame member and the back frame member, respectively.

12. The wheel detailing stand of claim 1 wherein the bottom frame member comprises a top plate and a bottom plate, the top plate having the pair of bottom rollers attached thereto, and wherein the top plate is rotatable relative to the bottom plate.

13. The wheel detailing stand of claim 11 wherein the top plate has a pivot hole and a locking hole formed therein and the bottom plate has a pivot hole and one or more locking holes formed therein; and
wherein the bottom frame member further comprises:
a plurality of roller balls positioned between the top plate and the bottom plate; and
a pivot pin extending through the pivot holes in the top plate and the bottom plate;
wherein the plurality of roller balls and the pivot pin enable rotation of the top plate relative to the bottom plate.

14. The wheel detailing stand of claim 13 further comprising a locking pin selectively positionable through the locking hole of the top plate and through one of the one or more locking holes of the bottom plate, wherein positioning of the locking pin in the locking hole of the top plate and through one of the one or more locking holes of the bottom plate locks the top plate relative to the bottom plate and prevents rotation of the top plate relative to the bottom plate.

15. A wheel detailing stand for detailing or cleaning a wheel, the wheel detailing stand comprising:
a base frame; and
a plurality of idle rollers positioned on the base frame and arranged thereon to receive the wheel and provide 3-points of contact with the wheel.

16. The wheel detailing stand of claim 15 wherein the base frame comprises a bottom frame member and a back frame member, the back frame member extending upwardly from the bottom frame member so as to be oriented generally orthogonally thereto; and
wherein the plurality of idle rollers comprises:
a pair of bottom rollers attached to the bottom frame member, the pair of rollers arranged in parallel and spaced apart from one another; and
a back roller attached to the back frame member and oriented generally orthogonally to the pair of bottom rollers;
wherein the pair of bottom rollers and the back roller provide 3-point contact with a wheel positioned on the wheel detailing stand.

17. The wheel detailing stand of claim 16 wherein the pair of bottom rollers is angled relative to the bottom frame member from a front end of the rollers to a back end of the rollers, so as to tilt the wheel positioned on the wheel detailing stand back against the top roller.

18. The wheel detailing stand of claim 16 wherein the back roller is adjustable to vary an angle thereof relative to the back frame, so as to alter the point of contact of the back roller with the wheel.

19. The wheel detailing stand of claim 16 wherein the bottom frame member, comprises:
a top plate having the pair of bottom rollers attached thereto on a top surface;
a bottom plate in parallel with the top plate and spaced apart therefrom;
a plurality of roller balls positioned between the top plate and the bottom plate; and
a pivot pin extending through a pivot hole in each of the top plate and the bottom plate;
wherein the plurality of roller balls and the pivot pin enable rotation of the top plate relative to the bottom plate.

20. The wheel detailing stand of claim 19 further comprising a locking pin selectively positionable through a locking hole of the top plate and through one of one or more locking holes of the bottom plate, wherein positioning of the locking pin in the locking hole of the top plate and through the one of the one or more locking holes of the bottom plate locks the top plate relative to the bottom plate and prevents rotation of the top plate relative to the bottom plate.
